(19) United States
(12) Patent Application Publication
(10) Pub. No.: US 2014/0129353 A1
(43) Pub. Date: May 8, 2014

(54) ADVERTISING SYSTEM AND METHOD

(71) Applicant: Jakob Spevak, Beverly Hills, CA (US)

(72) Inventor: Jakob Spevak, Beverly Hills, CA (US)

(21) Appl. No.: 13/671,288

(22) Filed: Nov. 7, 2012

(51) Int. Cl. G06Q 30/02

(52) U.S. Cl. 705/14.73

(57) ABSTRACT

A device and method for advertising a product or service are described herein. The device may take a photograph of a participant holding the product or a thing representing the service. The participant identifies a product identifier of the product or service or the device. The product identifier and the photograph are uploaded to a third-party server that subsequently uploads basic product information and the photograph to the participant's online social network for viewing by the participant's contacts. The participant has a self-interested goal of presenting only relevant products and services to his or her contacts to maintain credibility.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a social network advertising system.

The fashion industry changes frequently. Oftentimes, there are several new clotheslines each year that contain hundreds of items. Each brand may also have a large variety of different types of products (e.g., cologne, perfume, etc.). To expose potential consumers to the new clotheslines and products, the brand must advertise these new clotheslines and products through TV commercials, billboards, Internet ads, store catalogs, etc. Moreover, the brands may display the new clotheslines and different types of products on their website. Unfortunately, each advertising channel provides limited exposure to potential customers of each of the clotheslines and products that they advertise. Typically, it is a few limited models, wearing a few new products. Another issue with the traditional advertising model is that the advertisements force the product on the consumer (i.e., interruption marketing). Another problem with the traditional advertising model is that consumers are unaware of the numerous types of products of a particular brand unless they actively seek out a product on the brand's website or store catalog.

Accordingly, there is a need in the art for an improved advertising method and system.

### BRIEF SUMMARY

The various aspects discussed herein address the needs discussed above, discussed below and those that are known in the art.

The device and method discussed herein allows a brand to utilize a participant's social network to advertise the brand's products. In particular, the participant takes a photograph with a product. The participant additionally identifies the product on the device. The device associates the photograph and a product identifier together and uploads this information to a third-party server. The third-party server uploads the photograph and basic product information to the participant's online social network. When the contacts of the participant's online social network view the photograph and the basic product information, the photograph of the participant attracts the contact's attention and if the contact is interested in the product or service, the contact may click on the photograph or the basic product information which contains an embedded link. Upon clicking the embedded link, the contact's web browser may be redirected to a website of the third-party server having detailed product information including but not limited to purchasing directions. In this manner, a brand may have broader dissemination of its products, endorsement from the participant to his or her contacts with whom the participant has credibility and exposure of its products to the right audience since the participant has a self interest in presenting only relevant products to his or her contacts.

More particularly, a method of advertising is disclosed which may comprise the steps of receiving a photo of a participant and a product; receiving a product identifier of the product; uploading the photo and basic product information of the product to one or more online social networking websites of the participant; and presenting detailed product information or product to one or more contacts within one or more online social network websites of the participant.

The method may further comprise the step of compensating the participant based on a number of presentations to contacts of the participants within the one or more social network websites of the participant.

In the method, the uploading step may further comprise the step of embedding a link in the photo or the basic product information to a third party server having detailed product information (e.g., purchasing directions and/or detailed product specification).

Additionally, the presenting step may comprise the step of serving detailed product information to one or more contacts of the person when the person clicks on the link displayed on the online social network website.

The link may be a text link or a visual depiction link. The product may be a good or service.

In another aspect, a device for facilitating advertisement of it product is disclosed. The device may comprise a camera and a processor. The processor may have software loaded on the processor for performing the steps of taking a photograph of a participant and a product with the camera; identifying a product identifier; and transmitting the photograph and the product identifier over an internet.

The software loaded on the processor may further perform the steps of scanning a barcode of the product with a scanner to identify the product identifier. Additionally or alternatively, the software loaded on the processor may perform the steps of drilling down through a series of menus with a touch screen, mouse and/or keyboard to the product or any similar system that allows the user to identify product and product identifier.

The transmitting step may include the step of transmitting the photograph and the product identifier to a third party server over the internet which subsequently transmits the photograph and basic product information to an online social network website. Alternatively, the transmitting step may include transmitting the photograph and the basic product information or a link thereof to an online social network website of the participant over the internet.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is as schematic diagram of a device in a store for taking a photograph of a participant and product and associating the photograph with a product identifier that can be uploaded to a third-party server;

FIG. 2 is a schematic diagram of the device and its relationship to the third-party server and one or more social network websites;

FIG. 3 is a schematic diagram of the relationship between the participant, third-party server, social network websites and contacts;

FIG. 4 is a schematic diagram of a status update page of a social network website; and

FIG. 5 is a flowchart of steps of the third-party server for implementing the advertising method described herein.

### DETAILED DESCRIPTION

Referring now to the drawings a unique advertising system and method is disclosed in which a participant's online social network 34 is utilized to advertise a product 18. By way of example and not limitation, a retail store 10 may have a device 12 capable of taking a photograph 20 of the participant 14 and the product 18. Moreover, the device 12 may be capable of associating product information with the photograph 20 taken by the device 12. The photograph 20 and basic product information 22 may be uploaded to one or more of the participants online social network 34 for viewing by the participant's contacts 42 or friends. The photograph 20 and/or the basic product information 22 may be embedded with a link to a third party website (e.g. store website selling the product 18 or third-party server website 24) which presents detailed product information 22 to the participant's contacts 42 or friends when the embedded link is clicked. Detailed product information 22 may include but is not limited to purchasing instructions, product specifications, etc. In this manner, the participant 14 endorses the product 18 for purchase by personally associating his or her image with the product 18 thereby urging his or her contacts to find out more information about the product 18. The participant 14 may be compensated by the retail store 10, product manufacturer or third-party 24 for participating in the dissemination of product information 22 to the participant's contacts 42 or friends on the participant's online social network.

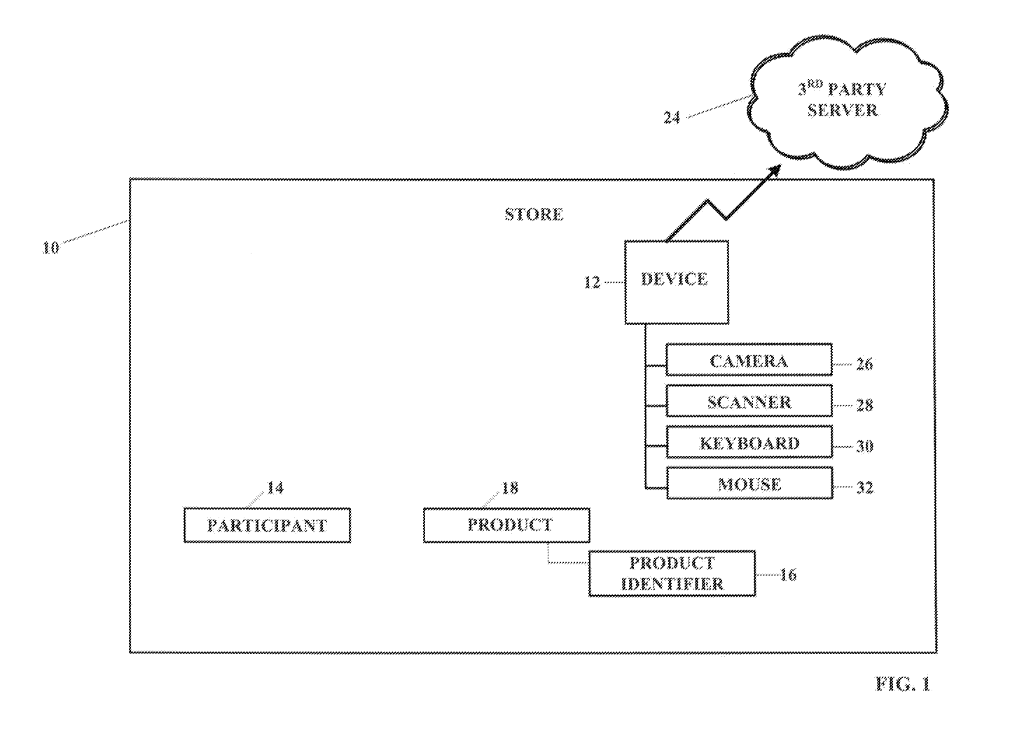

More particularly, referring now to FIG. 1, a store 10 may have the device 12 for taking photographs 20 of a participant 14, receiving a product identifier 16 and associating the product identifier 16 and the photograph 20. The store 10 may be a retail store or warehouse or some other type of physical location that displays products 18 for sale. The store 10 may sell or display products such as clothing, electronic devices, household items, groceries, software, insurance services, real estate services and any other type of goods and services. The term product 18 may include but is not limited to both goods and services. When the product 18 is a service, the participant 14 may take a photograph 20 of the participant 14 along with a brochure describing the service or a store front or a logo of the brand since a service cannot be seen. An insurance service may be represented by a sales person or a logo of the insurance company. The participant may take a photograph 20 of the logo of the insurance company or the logo of the insurance company may be electronically added to the photograph of the participant 14.

The device 12 for taking photographs 20 of participants 14 and receiving product identifiers 16 may be a standalone device 12 having a camera 26 for taking the photograph 20 of the participant 14 and an input accessory. The standalone device 12 may be located throughout the store 10 or at strategic locations such as next to a dressing room so that shoppers may take a photograph 20 of themselves with clothing to be advertised. The input accessory may be a barcode scanner 28 or other type of scanner for scanning and retrieving a product identifier 16 of the product 18. The input accessory may also be a keyboard 30 and/or mouse 32 that guides the participant 14 or store clerk in identifying the product 18 in the memory of the device 12 or network. Although the device 12 may be a standalone device 12 located in the store 10, it is also contemplated that the device 12 may be a desktop computer, tablet computer (e.g., iPad) with a program for taking the photograph 20 of the participant 14 and product 18. The device 12 may also be the participant's smart phone (e.g., iphone) with an application for implementing one or more steps of the method disclosed herein.

The participant 14 may enter a store 10. When the participant 14 sees a product 18 that he or she likes, the participant 14 may take a photograph 20 of him or herself 14 and the product 18 with the camera 26 of the device 12. After taking the photograph 20, the device 12 prompts the participant 14 or the store clerk to identify the photographed product 18. The participant 14 or the store clerk may scan a barcode on the product 18. Other methods of identifying the product 18 are also contemplated. By way of example and not limitation, the device 12 may provide the participant 14 or store clerk with a series of menus or options that the participant 14 or store clerk may choose with the keyboard 30 or mouse 32 to drill down and identify the specific product 18. By identifying the specific product 18, the product identifier 16 is retrieved. The barcode number may be the product identifier 16 or a different product identifier 16 may be retrieved from the store's 10 computer system based on the barcode information. The product identifier 16 may be associated with the photograph 20. The participant 14 provides permission to the retail store 10 or a third-party administering the advertising method and system to upload the photograph 20 and basic product information 22 of the product 18 on one or more social networking websites 34 to which the participant 14 belongs and has friends or contacts 42.

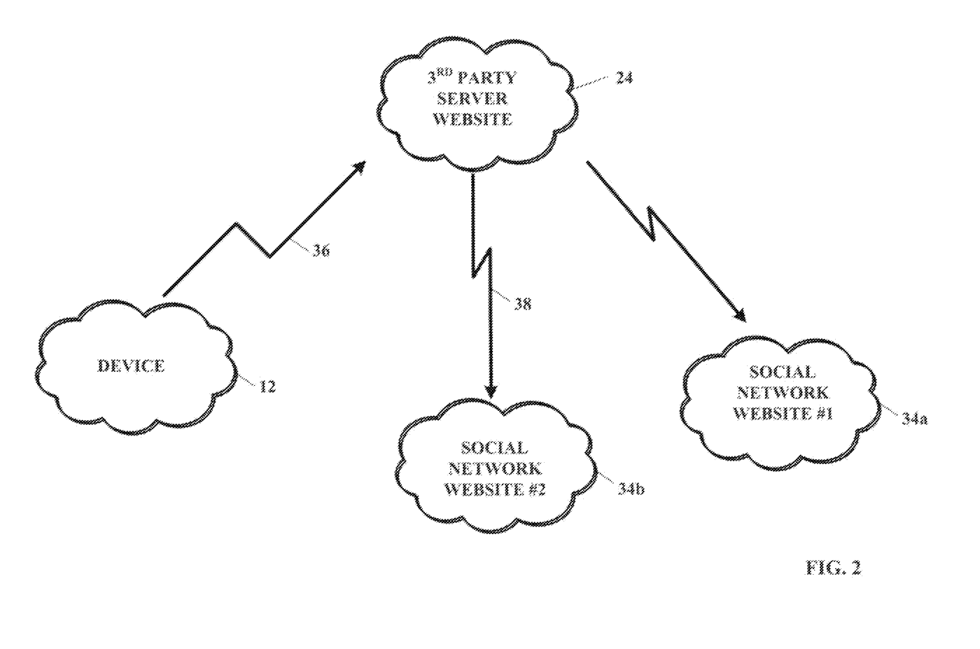

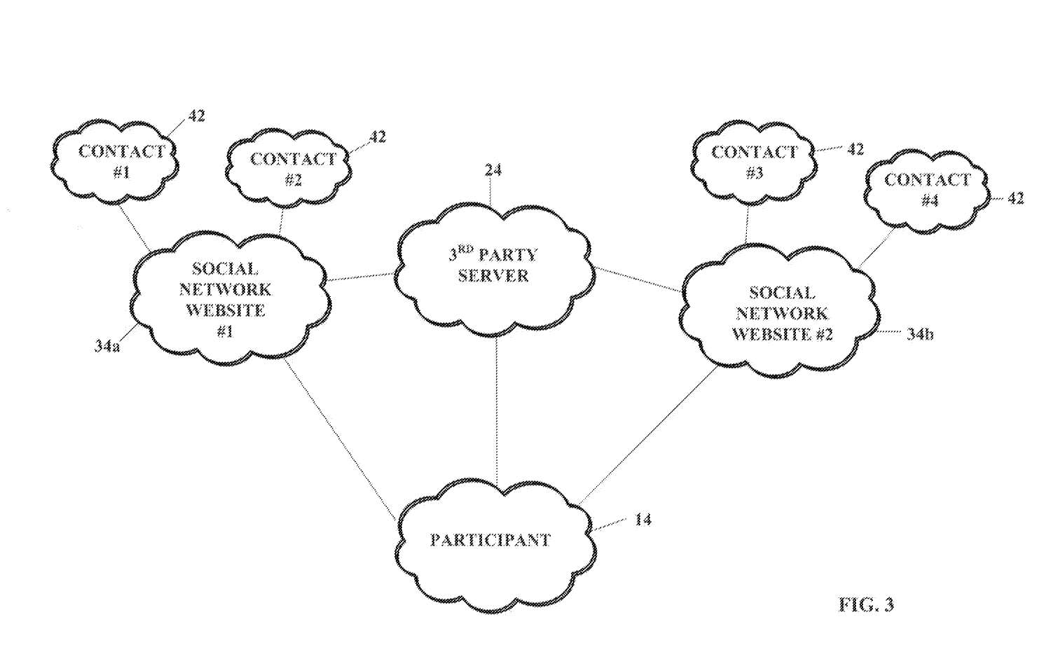

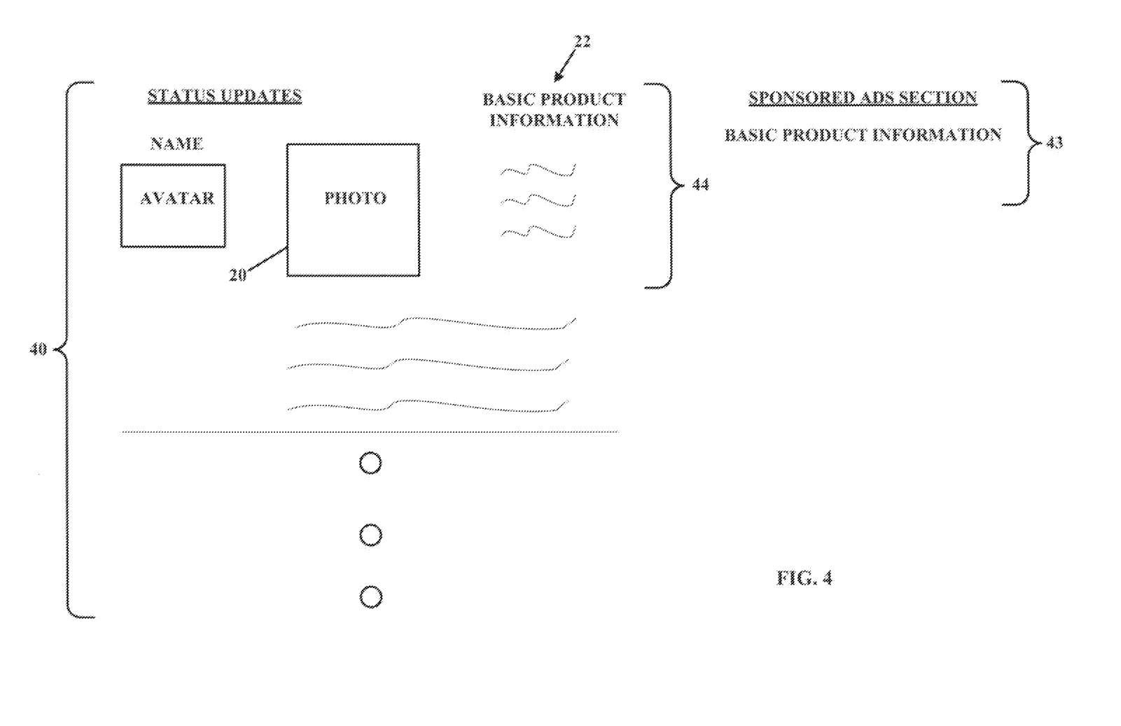

Referring now to FIG. 2, the device 12 uploads the photograph 20 and the product identifier 16 to the third-party server 24. The third-party server 24 uploads 38 the photograph 20 and basic product information 22 of the product 18 to the status update page 40 (see FIG. 4) on the one or more social network websites 34a, b of the participant 14. By uploading the photograph 20 and the basic product information 22 of the product 18 to the social network websites 34a, 34b to which the participant 14 belongs, the product is exposed to the contacts 42 of the participant 14, as shown in FIG. 3. The participant's 14 face initially attracts the contact's 42 attention and guides the contact's attention subsequently to the product 18 being advertised. The first social network website 34a may be Facebook through which the participant 14 establishes online contact with his or her personal friends. In contrast, the second social network website 34b may be LinkedIn through which the participant 14 establishes online contact with his or her work relationships. The product 18 being endorsed by the participant 14 may be related to a personal hobby of the participant 14. In this instance, the participant 14 can authorize uploads of the photograph 20 and the basic product information 22 of the product 18 to the first social network website 34a. (e.g., Facebook or even to a group on Facebook). On the other hand, if the product 18 being endorsed is work related (e.g., seminar), then the participant 14 may authorize upload of the photograph 20 and the basic product information 22 of the product 18 to the second social network website 34b (e.g. LinkedIn or a subgroup on LinkedIn). In this manner, the product 18 is being exposed to the right type of contacts 42 and endorsed by the participant 14 who has credibility with the contacts 42.

Referring now to FIG. 3, the participant 14 allows the third-party server 24 to establish contact with online social network websites 34a, b and more particularly allows the third-party server 24 to post the photograph 20 and basic product information 22 as a status update to the participants account on selective social network websites 34a, b or group so that the right type of products 18 are being shown to the right type of contacts 42 with which the participant 14 has earned credibility. Moreover, instead of being capable of providing authorization to post status updates on one but not another social network website 34, the system and method described herein also contemplates being capable of providing authorization to post status updates to one or more subgroups or focus groups or private groups on the social network website 34.

Referring now to FIG. 4, a status update page 40 of a contact 42 of the participant 14 is shown. The status update page 40 may have an entry 44 including the photograph 20 and the basic product information 22. The photograph 20 and/or the basic product information 22 may be embedded with a link which when clicked redirects the contacts 42 web browser to the third-party server website 24 through which detailed product information 22 is presented to the contact 42. The detailed product information 22 may include purchasing directions (i.e., a means by which the contact 42 can purchase the product 18) or other call to action (e.g., subscribe to newsletter, like on Facebook, tweet on twitter). Moreover, the detailed product information 22 may also include other relevant data and information to assist the contact 42 in making a purchasing decision regarding the product 18.

The link which when clicked redirects the contact's 42 web browser to the third-party server website 24 may also be a separate standalone link 43 and not embedded in the photograph 20 or the basic product information 22. As shown in FIG. 4, the standalone link may be in the Sponsored Ads Section of the status update page.

The participant 14 may be compensated by way of a discount on the product 18 should the participant 14 purchase the product 18 being advertised. Compensation to the participant 14 may be based on the number of photos 20 shared on the participants social network, the number of contacts 42 of the participant 14, number of impressions of the basic product information 22 to the participant's contacts 42, number of impressions of the detailed product information 22 to the participant's contacts 42 (i.e., click through by contacts), the number of ‘likes’ of a photo 20 on the social network, or a combination thereof. The compensation may be on a different product unrelated to the product in the photograph 20. These metrics can be monitored in real time by the retail store in order to calculate the discount or compensation to be extended to the participant 14.

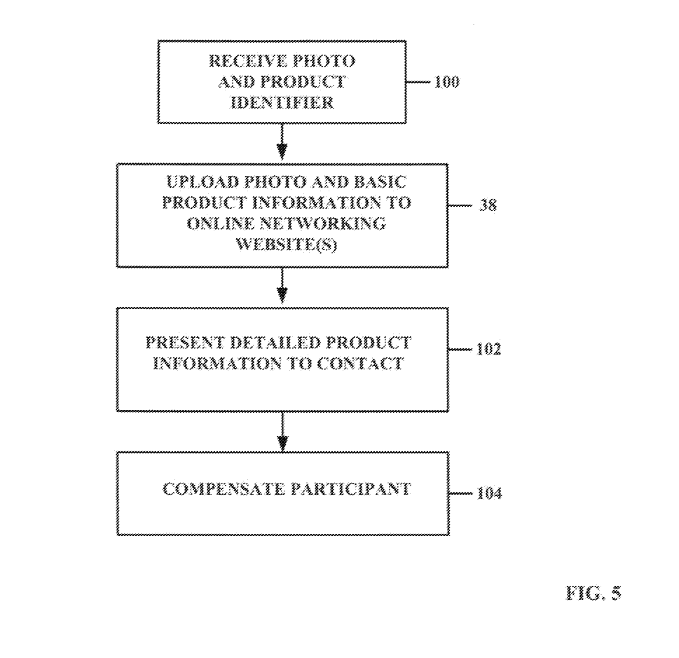

Referring now to FIG. 5, a flowchart of the various steps performed by the third-party server 24 is shown. After the participant 14 takes the photograph 20 and the device 12 associates the photograph 20 with the product identifier 16, the photograph 20 and the product identifier 16 are electronically delivered to the third-party server 24. The third-party server 24 receives 100 the photograph 20 and the product identifier 16. The product identifier 16 may be a barcode number. The product identifier 16 may be an alphanumeric string common between the store 10 and the third-party server 24. Regardless of the form of the product identifier 16, the product identifier 16 identifies the particular product 18 to be advertised within the database of the third-party server 24. Along with the product identifier 16 and the photograph 20, the participant's data may also be transformed to the third-party server 24. The participant's data provides the third-party server 24 with permission to update the status feed of the participant 14 on the online social network websites 34a, b to which the participant 14 belongs. Also, the third party server 24 may open an account on a third party server for the participant 14 for the purpose of compensating the participant 14. The photograph 20 and product identifier 16 may be stored in a database on the third-party server 24. The photograph 20 and product identifier 23 may also be stored with information related to purchasing directions and product specifications.

The third-party server 24 accesses the online social network websites 34a, b of the participant 14 and updates the participant's 14 status on those online social network websites 34a, b. To update the participant's 14 status, the third-parry server 24 uploads 38 the photograph 20 and basic product information 22 to the online social network websites 34a, b of the participant 14. The contacts 42 of the participant 14 are shown the photograph 20 of the participant 14 and the basic product information 22. The photograph 20 or the basic product information 22 may be embedded with a link or a separate link may be shown to the contact 42 through the social network website 34. When the contact 42 clicks the link, the contact's web browser is redirected to a webpage having detailed product information 22 including but not limited to purchasing directions. The third party server 24 may present 102 detailed product information 22 to the contact 42.

The participant 14 may be compensated 104 based on one or more factors as discussed above.

The product 18 may be a good or service including but not limited to clothing, an electronic device, a person (e.g. person running for elected office), a service such as insurance, real estate services, real estate agents.

Although the various aspects of the method and device described herein were described in relation to a physical store, it is also contemplated that the various aspects of the method and device may be implemented with a product 18 delivered to the participant 14 at the participant's home or business. The participant 14 may take a photograph 20 of him or herself with the product 18 and upload the photograph 20 to the third-party server 24. The participant 14 may also identify the product 12 by the product identifier 16 or through a series of menus designed to facilitate identification of the product 18 on the website of the third-party server 24 or an online store for the product 18. The device 12 would be the participants computer, laptop computer, tablet computer, smart phone or combination camera and computer.

The website of the third-party server 24 may present basic product information 22 and/or detailed product information directly to consumers who finds the website of the third party server 24 through an Internet search or by directly typing in the World Wide Web address of the website or the third-party server 24. The website of the third-party server 24 may present categories of products 18 that the consumer would like to purchase. Moreover, the website of the third-party server 24 may enable consumers to follow a particular participant 14 who they think would provide recommendations on products 18 that the consumer might like. The participant 14 may be compensated by the participant's 14 number of followers in conjunction with one or more of the other factors discussed above or exclusively based on the participant's 14 number of followers.

In the description of the advertising method and system, the basic product information 22 may be presented to the contacts 42 of the participant 14 by placing the basic product information 22 adjacent to the photograph 20. However, it is also contemplated that the basic product information 22 may be superimposed on the photograph 20. Moreover, it is also contemplated that the device 12 may also superimpose a logo of the store 10 on the photograph 20 or adjacent thereto. It is further contemplated that the basic product information 22 in the status update page 40 or the superposed basic product information 22 on the photograph 20 may be removed so that it is less obvious that the participant 14 is promoting a product. For example, in the status update page 40, the photograph 20 may depict the participant 14 and the product with an optional comment by the participant. The basic product information 22 or the product being advertised may be placed in the sponsored ads section 43.

The device 12 and the third-party server 24 may provide other options to the participant 14 and store 10. The participant 14 may be allowed to delete a photo 20 after being uploaded to the third-party server 34. Moreover, the store 10 or the third-party server 24 may delete the photo 20 uploaded by the participant 14.

The various aspects of the method and device described herein transfer information from the device 12 to the third party server 24 then to the participant's online social network. However, it is also contemplated that the photograph 20 and the basic product information 22 may be uploaded to the participant's online social network directly from the device 12. In other words, the third party server 24 may provide the participant with a link that the participant may post to his or her status page on his or her online social network websites. The online social network website accesses photographs associated with the link by accessing the third party server 24 when the participant 14 is posting the link to the online social network website(s). The participant 14 selects the appropriate photograph 20 and posts the link. Upon posting the link, an electronic signal is sent to the third party server 24 from the online social network websites that the link was posted for the purposes of compensation and/or tracking.

The above description is given by way of example, and not limitation. Given the above disclosure, one skilled in the art could devise variations that are within the scope and spirit of the invention disclosed herein, including various ways of taking the photograph and the product/service. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of advertising comprising the steps of:
receiving a photo of a participant and a product;
receiving a product identifier of the product;
uploading the photo and bask product information of the product to one or more online social networking websites of the participant; and
presenting detailed product information of the product to one or more contacts within one or more online social network websites of the participant.

2. The method of claim 1 further comprising the step of compensating the participant based on a number of presentations to contacts of the participants within the one or more social network websites of the participant.

3. The method of claim 1 wherein the uploading step further comprises the step of:
embedding a link in the photo or the basic product information to a third party server having detailed product information.

4. The method of claim 3 wherein the presenting step comprising the step of serving detailed product information to one or more contacts of the person when the person clicks on the link displayed on the online social network website.

5. The method of claim 3 wherein the link is a text link or a visual depiction link.

6. The method of claim 1 wherein the product is a good or service.

7. A device for facilitating advertisement of a product, the device comprising:
a camera;
a processor having software loaded thereon to perform the following steps of:
taking a photograph of a participant and a product with the camera;
identifying a product identifier;
transmitting the photograph and the product identifier over an internet.

8. The device of claim 7 wherein the software loaded on the processor further performs the steps of scanning a barcode of the product with a scanner to identify the product identifier.

9. The device of claim 7 wherein the software loaded on the processor further performs the steps of drilling down through a series of menus with a mouse and/or keyboard to the product.

10. The device of claim 7 wherein the transmitting step includes the step of transmitting the photograph and the product identifier to a third party server over the internet.

11. The device of claim 7 wherein the transmitting step includes transmitting the photograph and the product identifier or a link thereof to an online social network website of the participant over the internet.
